(19) United States
(12) Patent Application Publication
(10) Pub. No.: US 2012/0010941 A1
(43) Pub. Date: Jan. 12, 2012

(54) EMAIL BASED SOCIAL ADVERTISEMENTS

(75) Inventor: JIN SUK PARK, Seoul (KR)

(73) Assignee: Yahoo! Inc., Sunnyvale, CA (US)

(21) Appl. No.: 12/831,692

(22) Filed: Jul. 7, 2010

(51) Int. Cl. G06Q 30/00; G06F 15/16

(52) U.S. Cl. 705/14.41; 709/206

(57) ABSTRACT

The present invention provides techniques for use in advertising in connection with email. Techniques are provided in which a user allows placement of advertisements in the user's outgoing emails, or outgoing emails to users in a social network of the user, for which the user is provided some benefit. The benefit is based at least in part on performance of the advertisements. The user provides input with regard to one or more parameters relating to the advertisements. For example, the user may select a category or a particular product associated with the advertisements.

### BACKGROUND

Email has become a key form of communication, both for business and social purposes. Furthermore, online social applications and social networking has grown dramatically. Yet, effective techniques for monetizing these spaces have proved elusive.

There is a need for more effective techniques for advertising in connection with email.

### SUMMARY

The present invention provides techniques for use in advertising in connection with email. Techniques are provided in which a user allows placement of advertisements in the user's outgoing emails, or outgoing emails to users in a social network of the user, for which the user is provided some benefit. The benefit is based at least in part on performance of the advertisements. The user provides input with regard to one or more parameters relating to the advertisements. For example, the user may select a category or a particular product associated with the advertisements. The user may also have input on or select a revenue sharing model to be utilized with regard to the benefit, such as a model based on performance metrics, such as click-related, conversion-related, or impression-related performance metrics, associated with the advertisements.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

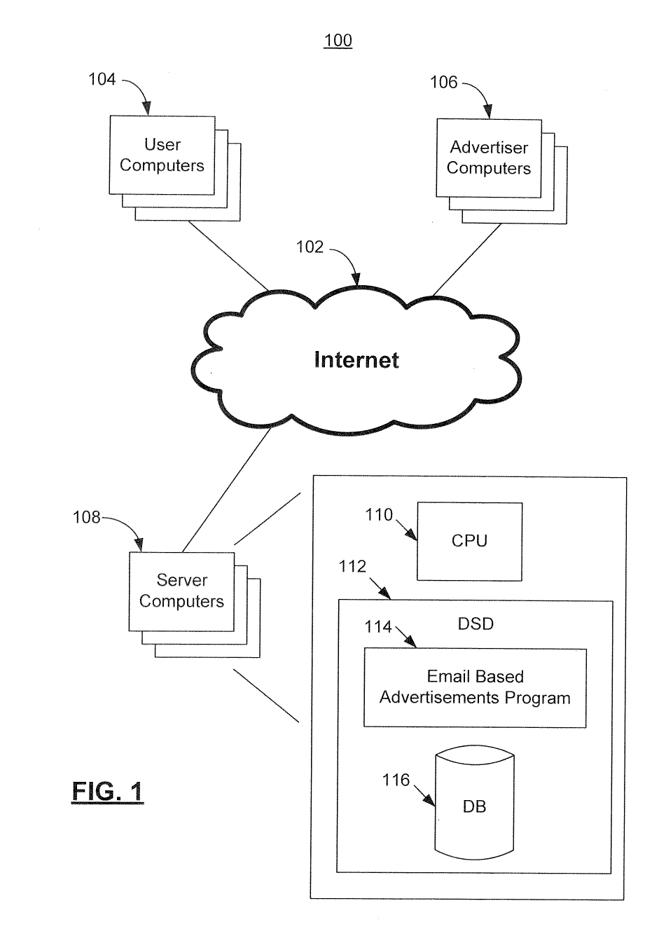

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Email Based Advertisements Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

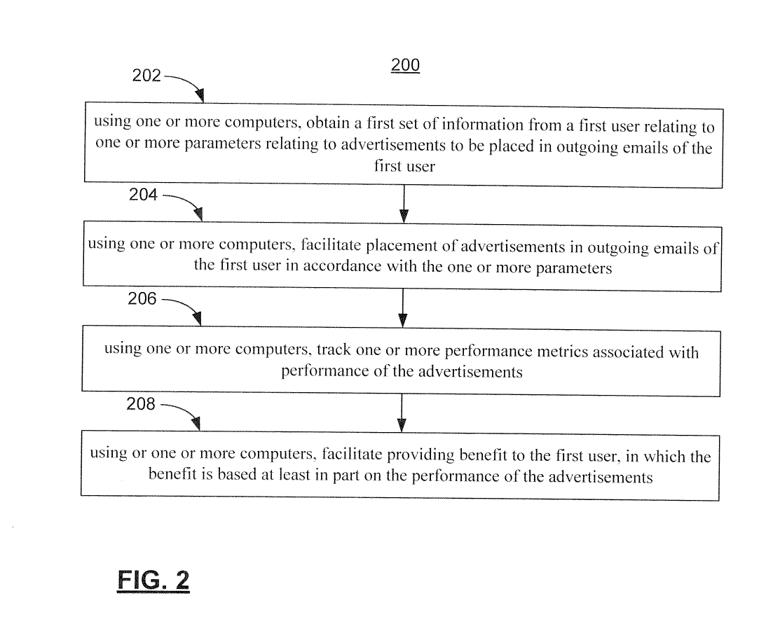

FIG. 2 is a flow diagram illustrating a method 200 according to one embodiment of the invention. At step 202, using one or more computers, a first set of information is obtained from a first user relating to one or more parameters relating to advertisements to be placed in outgoing emails of the first user.

At step 204, using one or more computers, placement is facilitated of advertisements in outgoing emails of the first user in accordance with the one or more parameters.

At step 206, using one or more computers, tracking is performed of one or more performance metrics associated with performance of the advertisements.

At step 208, using or one or more computers, the method 200 includes facilitating providing benefit to the first user, in which the benefit is based at least in part on the performance of the advertisements.

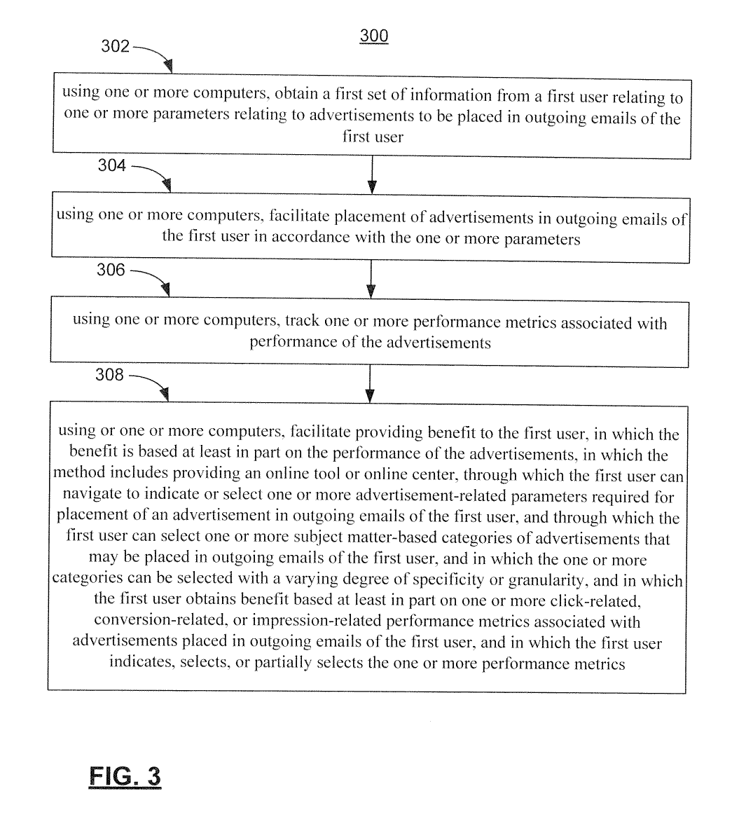

FIG. 3 is a flow diagram illustrating a method 300 according to one embodiment of the invention. Steps 302, 304 and 306 of the method 300 depicted in FIG. 3 are similar to steps 202, 204 and 206 of the method 200 depicted in FIG. 2.

At step 308, using or one or more computers, the method 300 includes facilitating providing benefit to the first user, in which the benefit is based at least in part on the performance of the advertisements. Step 308 further includes providing an online tool or online center, through which the first user can navigate to indicate or select one or more advertisement-related parameters required for placement of an advertisement in outgoing emails of the first user, and through which the first user can select one or more subject matter-based categories of advertisements that may be placed in outgoing emails of the first user. The one or more categories can be selected with a varying degree of specificity or granularity. The first user obtains benefit based at least in part on one or more click-related, conversion-related, or impression-related performance metrics associated with advertisements placed in outgoing emails of the first user. Furthermore, the first user indicates, selects, or partially selects the one or more performance metrics.

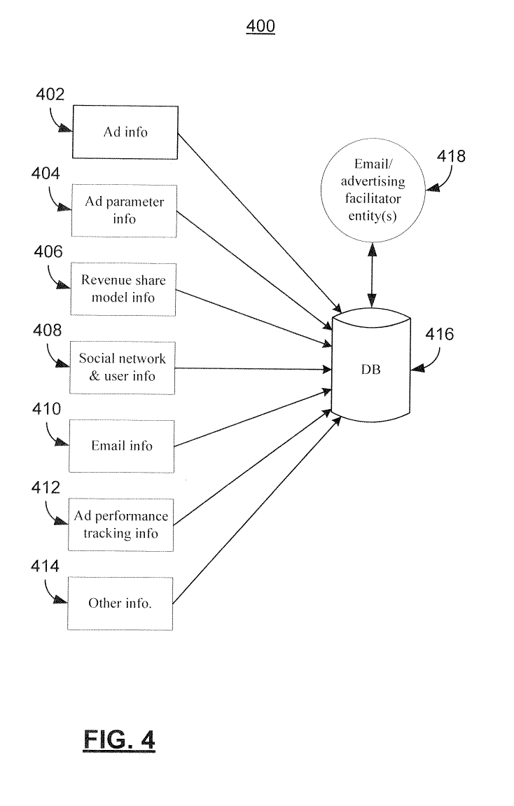

FIG. 4 is a block diagram 400 illustrating one embodiment of the invention. Depicted are various types of information that may be stored in one or more data stores or databases 416, according to some embodiments of the invention. In particular, such types of information can include advertisement information 402 (which can include product, service or brand information, etc.); advertisement parameter information 404; revenue share model information 406; social network and user information 408; email information 410; advertisement performance tracking information 412; and potentially various types of other information 414. The database 416 may be accessible and used by one or more email and/or advertising facilitator entities 418, such as a Web portal, for example, with which a user may arrange for advertisements to be placed, and which may facilitate placement of advertisements, tracking of advertisement performance, etc.

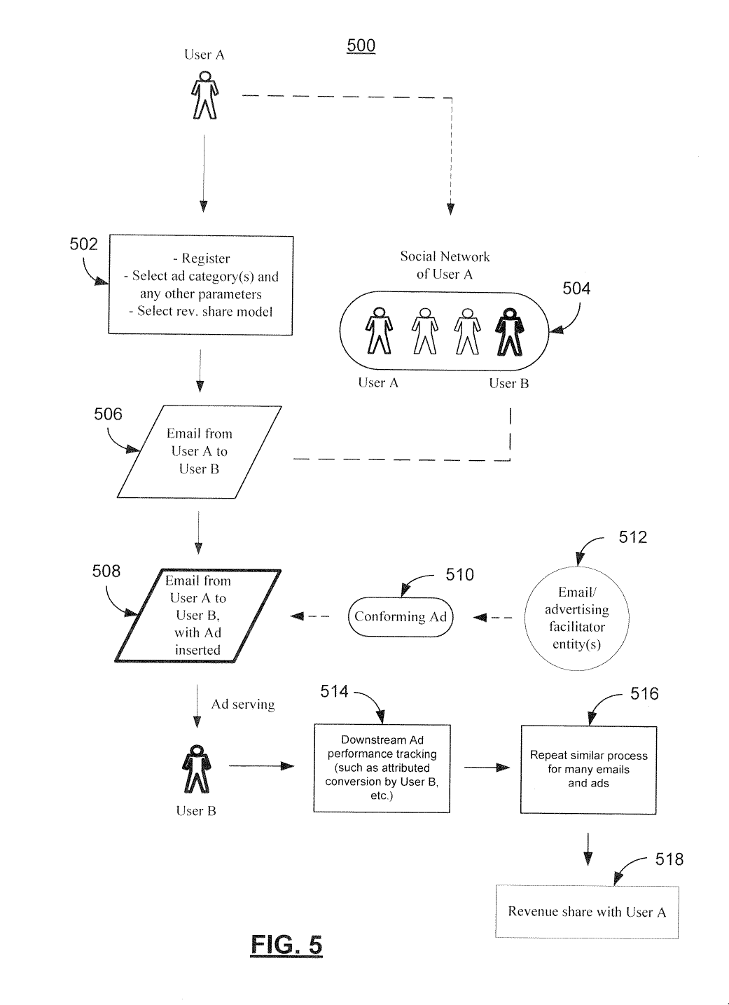

FIG. 5 is a block diagram 500 illustrating one embodiment of the invention. Block 502 represents various actions that a user, such as User A, as depicted, may take, or may need to take, in order to set up an arrangement in which advertisements are placed in his or her outgoing emails, according to embodiments of the invention. In particular, User A may register for the service or arrangement. In addition, User A may select one or more categories (or specific products, services, brands, etc.), or other parameters that will be required for placement of the advertisements. Furthermore, User A may select, or provide input relating to, the type of revenue share model that will be utilized. For example, User A may benefit, such as by obtaining payment, based at least in part on performance of the placed advertisements, such as number of impressions, number of click throughs or other actions, number of conversions or purchases, etc. In some embodiments, any of various measures may be taken to prevent click fraud, in connection with advertisement performance tracking and revenue sharing models.

Block 506 represents an email from User A to User B, who may be a user in a social network 504 of User A, such as a friend of user A.

Block 508 represents the email from User A to User B after insertion of an advertisement according to an embodiment of the invention. In various embodiments, the advertisement can be inserted at different times and in different ways, so that, when a recipient opens or reads the email, the advertisement or impression exists or appears. In some embodiments, in addition to being in accordance with parameters specified by User A, the advertisement may also be suited to the content of the email or the anticipated recipient user or user group, or may also be targeted in any other way or ways known in the art. Furthermore, some embodiments include content-based, or sponsored or search-based listings. Still further, some embodiments include one or more advertisement placed in each email in connection with an auction-based bidded marketplace.

As depicted, an email or advertising facilitator entity 512, such as a Web portal, provides or facilitates providing a conforming advertisement 510 for insertion in the email, which advertisement conforms to parameters indicated or chosen by User A. The entity 512 may also facilitate insertion or incorporation of the advertisement into the email. The email, including the advertisement, is served to User B.

At step 514, downstream advertisement performance tracking is performed in connection with the advertisement served to User B.

At step 516, a similar process or technique is followed for numerous advertisements and impressions in connection with emails from User A.

At step 518, a particular revenue share technique, plan or model is utilized in determining benefit, such as payment, to be provided to User A in connection with outgoing emails including advertisements, which may be based at least in part on cumulative performance tracking, which can include simply one or more counts such as a count of impressions, conversions, etc., in connection with outgoing emails including advertisements, and impressions served as a result of them.

In some embodiments of the invention, an email user becomes a publisher, or like a publisher, in which the user's emails become the platform or venue in which advertisements can be placed, similar to a Web site operator who allows or arranges for advertising on pages of the Web site. In some embodiments, various other features such as targeting, etc., may be similar to those of services and technologies used in connection with publishers or small publishers that allow online advertisements to be placed on their venues or platforms. In some embodiments, however, advertisement performance may be considerably better than many such arrangements, because the email user emails or may email people in the email user's social network, who may be more likely to share interests with the email user, which interests may be reflected in the advertisements. Additionally, an implicit or explicit endorsement of the email user may lead to even greater advertisement performance.

Some embodiments of the invention include a social aspect. For example, a user who agrees or arrangements for advertisements in the user's outgoing emails can use the situation to provide suggestions or recommendations to family, friends, or others in the user's social network regarding products, services, brands, etc. This may be especially valuable or enjoyable to the user, in that people in the user's social network are likely to share similar interests. For example, if the user is an avid video gamer, many his friends are also likely to be video garners. As such, the user may enjoy choosing advertisements for the user's emails that relate to video games or game consoles, or particular video games or consoles, or types or categories of video games, etc., and this may help lead to effective advertising.

Furthermore, in some embodiments, the email user may also have influence or control over the revenue share model utilized to determine revenue to the email user, or even how much benefit or payment that the email user obtains per some unit in a metric or metrics of advertisement performance, etc. This may allow the email user to select an optimal model for the email user, increasing the email user's enthusiasm, desire to participate, and desire to make optimal decisions or selections with regard to advertisement parameters.

In some embodiments, an online tool, such as a Web-based center or ad center, is provided for the use of email users. In some embodiments, the ad center can be used by an email user to register and set up arrangements and details relating to having advertisements placed in the email user's emails. Additionally, in some embodiments, the ad center can be utilized by the email user to provide input and make selections regarding parameters for advertisements, and possibly also regarding revenue share model utilization or other aspects or details of arrangements. For example, in some embodiments, the email user can navigate through various screens or pages of the ad center in making selections regarding types, categories, products, services, or brands, to which placed advertisements must relate, or to which the subject matter of placed advertisements must be limited. Furthermore, in some embodiments, the email user can make such selections at various levels of detail or granularity. For example, the user may choose advertisements relating to electronics, or may go on to choose only advertisements relating to cell phones, or even advertisements relating to a particular brand or model of cell phones, etc. Still further, in some embodiments, the email user can even select particular advertisement groups or individual advertisements.

In some embodiments, the email user can also make selections regarding other limitations on advertisements, such as limitation on content, format, targeting parameters, etc.

While the invention is described with reference to the above drawings, the drawings are intended to be illustrative, and the invention contemplates other embodiments within the spirit of the invention.

1. A method comprising:
using one or more computers, obtaining a first set of information from a first user relating to one or more parameters relating to advertisements to be placed in outgoing emails of the first user;
using one or more computers, facilitating placement of advertisements in outgoing emails of the first user in accordance with the one or more parameters;
using one or more computers, tracking one or more performance metrics associated with performance of the advertisements; and
using or one or more computers, facilitating providing benefit to the first user, wherein the benefit is based at least in part on the performance of the advertisements.

2. The method of claim 1, wherein obtaining the first set of information from a first user comprises obtaining information relating to one or more characteristics or requirements relating to advertisements that may be placed in outgoing emails of the first user.

3. The method of claim 1, wherein obtaining the first set of information from a first user comprises obtaining information relating to one or more types of advertisements that may be placed in outgoing emails of the first user.

4. The method of claim 1, wherein obtaining the first set of information from a first user comprises obtaining information relating to one or more categories of advertisements that may be placed in outgoing emails of the first user.

5. The method of claim 1, wherein obtaining the first set of information from a first user comprises obtaining one or more indications or selections relating to one or more subject matter-associated, product or product type-associated, service or service type-associated, or brand-associated categories of advertisements that may be placed in outgoing emails of the first user.

6. The method of claim 1, wherein obtaining the first set of information from a first user comprises obtaining one or more indications or selections relating to one or more advertisements that may be placed in outgoing emails of the first user.

7. The method of claim 1, wherein advertisements are only placed in outgoing emails of the first user to users in a social network, or selected users in a social network, of the first user.

8. The method of claim 1, wherein a first advertisement placed in an outgoing email from the first user includes an explicit recommendation or endorsement from the first user relating to a subject of the first advertisement.

9. The method of claim 1, wherein the first user registers as a publisher prior to placement of the advertisements in outgoing emails of the first user.

10. The method of claim 1, wherein the first user obtains benefit based at least in part on one or more click-related, conversion-related, or impression-related performance metrics associated with advertisements placed in outgoing emails of the first user.

11. The method of claim 1, wherein the first user obtains benefit based at least in part on one or more click-related, conversion-related, or impression-related performance metrics associated with advertisements placed in outgoing emails of the first user, and wherein the first user indicates, selects, or partially selects the one or more performance metrics.

12. The method of claim 1, comprising providing an online tool or online center, through which the first user can navigate to indicate or select one or more advertisement-related parameters required for placement of advertisements in outgoing emails of the first user.

13. The method of claim 1, comprising providing an online tool or online center for use by the first user, through which the first user can navigate to indicate or select one or more advertisement-related parameters required for placement of an advertisement in outgoing emails of the first user, and through which the first user can select one or more subject matter-based categories of advertisements that may be placed in outgoing emails of the first user, and wherein the one or more categories can be selected with a varying degree of specificity or granularity.

14. The method of claim 1, wherein the first user can indicate or select one or more products, services, or brands, and wherein advertisements placed in outgoing emails of the first user must relate to the indicated or selected one or more products, services, or brands.

15. A system comprising:
one or more server computers coupled to a network; and
one or more databases coupled to the one or more server computers:
wherein the one or more server computers are for:
obtaining, and storing in at least one of the one or more databases, a first set of information from a first user relating to one or more parameters relating to advertisements to be placed in outgoing emails of the first user;
facilitating placement of advertisements in outgoing emails of the first user in accordance with the one or more parameters;
tracking one or more performance metrics associated with performance of the advertisements; and
facilitating providing benefit to the first user, wherein the benefit is based at least in part on the performance of the advertisements.

16. The system of claim 15, wherein network comprises the Internet.

17. The system of claim 15, comprising placing emails in outgoing emails of the first user in accordance with the one or more parameters.

18. The system of claim 15, comprising providing an online tool or online center, through which the first user can navigate to indicate or select one or more advertisement-related parameters required for placement of an advertisement in outgoing emails of the first user, and through which the first user can select one or more subject matter-based categories of advertisements that may be placed in outgoing emails of the first user, and wherein the one or more categories can be selected with a varying degree of specificity or granularity.

19. The system of claim 15, wherein the first user can indicate or select one or more products, services, or brands, and wherein advertisements placed in outgoing emails of the first user must relate to the indicated or selected one or more products, services, or brands.

20. A computer readable medium or media containing instructions for executing a method comprising:
using one or more computers, obtaining a first set of information from a first user relating to one or more parameters relating to advertisements to be placed in outgoing emails of the first user:
using one or more computers, facilitating placement of advertisements in outgoing emails of the first user in accordance with the parameters;
using one or more computers, tracking one or more performance metrics associated with performance of the advertisements; and
using or one or more computers, facilitating providing benefit to the first user, wherein the benefit is based at least in part on the performance of the advertisements;
comprising providing an online tool or online center, through which the first user can navigate to indicate or select one or more advertisement-related parameters required for placement of an advertisement in outgoing emails of the first user, and through which the first user can select one or more subject matter-based categories of advertisements that may be placed in outgoing emails of the first user, and wherein the one or more categories can be selected with a varying degree of specificity or granularity; and
wherein the first user obtains benefit based at least in part on one or more click-related, conversion-related, or impression-related performance metrics associated with advertisements placed in outgoing emails of the first user, and wherein the first user indicates, selects, or partially selects the one or more performance metrics.
